(19) United States
(12) Patent Application Publication
(10) Pub. No.: US 2019/0058739 A1
(43) Pub. Date: Feb. 21, 2019

(54) BLUETOOTH DATA ACCESS SYSTEM

(71) Applicant: Linctronix Ltd., New Taipei City (TW)

(72) Inventors: Yu-Shun Lin, New Taipei City (TW); Kuei-Han Chen, New Taipei City (TW)

(21) Appl. No.: 16/056,034

(22) Filed: Aug. 6, 2018

(30) Foreign Application Priority Data
Aug. 21, 2017 (TW) 106128301

(51) Int. Cl. H04L 29/06; H04W 4/80; H04L 29/08; H04W 48/10; H04W 88/16

(52) U.S. Cl. CPC H04L 65/1036; H04L 65/1063; H04W 88/16; H04L 67/125; H04W 48/10; H04W 4/80

(57) ABSTRACT

A Bluetooth data access system comprises a Bluetooth device, a Bluetooth gateway, and an application server. The Bluetooth gateway receives a service code from the Bluetooth device and sends the service code to the application server for getting an application able to communicate with the Bluetooth device. Then, the Bluetooth gateway controls or accesses the Bluetooth device through the application. Compared with the prior art, a Bluetooth gateway of the prior art requires a built-in application of the Bluetooth device to control the Bluetooth device. The present invention utilizes the application server to provide a corresponding application to the Bluetooth gateway based on the different Bluetooth device, so that the gateway can dynamically control or access various Bluetooth devices without the built-in application.

### CROSS-REFERENCE TO RELATED APPLICATIONS

This application claims the priority benefit of Taiwan Application Serial No. 106128301 filed Aug. 21, 2017 the disclosure of which is incorporated herein by reference.

### BACKGROUND OF THE INVENTION

### Field of the invention

The present invention relates to a Bluetooth data access system, more particularly, to a Bluetooth data access system searching application automatically.

### Description of the Prior

With the development of science and technology, the function of the sensing instrument is also progressing. Conventional sensing instruments, such as weight meters or blood sugar machines, usually have only the sensing function. The user must record the sensed value himself, which is cumbersome and the record is easily lost. Nowadays, a sensing instrument with sensing function is often integrated with the internet of things. The sensed value is smartly recorded in the instrument or uploaded to the cloud. Moreover, the instrument or the cloud correspondingly recommends the user according to the sensed value.

A smart sensing instrument is convenience, but the corresponding application is required to operate or access the instrument. However, each manufacturer or instrument has its own application. That also means if the user has five smart sensing instruments at home, five applications should be installed to operate the instruments. Therefore, it causes the user's inconvenience.

### SUMMARY OF THE INVENTION

In response to the above-mentioned problems, an object of the present invention is to provide a Bluetooth data access system comprising a Bluetooth device, a Bluetooth gateway, and an application server. The Bluetooth device is for sending a broadcast message. The Bluetooth gateway is coupled to the Bluetooth device to receive the broadcast message, and then the Bluetooth gateway sends a gateway message containing the broadcast message. The application server is connected to the Bluetooth gateway to receive the gateway message, and the application server generates and sends an application message according to the gateway message. Wherein, the Bluetooth gateway receives the application message, generates a control message, and then sends the control message to access or operate the Bluetooth device.

In an embodiment, the broadcast message comprises a device identified code, a universally unique identifier, or a combination thereof. The device identified code is a unique identified code of the Bluetooth device, and the universally unique identifier is an identified code of service contents for the Bluetooth device. The gateway message contains the broadcast message and a gateway identified code. The gateway identified code is a unique identified code of the Bluetooth gateway.

In an embodiment, the application server comprises a data collection module; the data collection module prestores an application able to communicate with Bluetooth device, the device identified code of the Bluetooth device, the universally unique identifier of the Bluetooth device, and the gateway identified code of the Bluetooth gateway. The application server selects the application and generates the application message containing the application according to the gateway message and the related data in the data collection module.

In an embodiment, the Bluetooth gateway comprises a computing unit. After the Bluetooth gateway receives the application message, the computing unit translates the application message to the control message, and then the control message is used to access or operate the Bluetooth device.

In practice, the Bluetooth gateway accesses or operates the Bluetooth device to obtain a service message content, and the Bluetooth gateway sends the service message content to the application server to integrate or analyze the data.

Compare with the prior art, the Bluetooth data access system of the present invention provides the corresponding application to the Bluetooth gateway according to different Bluetooth devices from the application server, so that the Bluetooth gateway can dynamically access or operate various Bluetooth devices without the inherent application, unlike the normal Bluetooth gateway requires the inherent application for various Bluetooth devices to access or operate the Bluetooth devices. Therefore, compared with the normal Bluetooth gateway, the Bluetooth gateway of the present invention can save the storage capacity for various applications. Moreover, the user could operate the different Bluetooth devices conveniently without installing on user's own.

### BRIEF DESCRIPTION OF THE APPENDED DRAWINGS

Some of the embodiments will be described in detail, with reference to the following figures, wherein like designations denote like members, wherein:

FIG. 1 shows a functional block diagram of the embodiment of the Bluetooth data access system of the present invention.

FIG. 2 shows another functional block diagram of the embodiment of the Bluetooth data access system of the present invention.

FIG. 3 shows a schematic diagram of the embodiment of the Bluetooth data access system of the present invention.

FIG. 4 shows a functional block diagram of the data collection module of the embodiment of the Bluetooth data access system of the present invention.

FIG. 5 shows another functional block diagram of the data collection module of the embodiment of the Bluetooth data access system of the present invention.

The advantages, spirits, and features of the present invention will be explained and discussed with embodiments and figures as follows.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

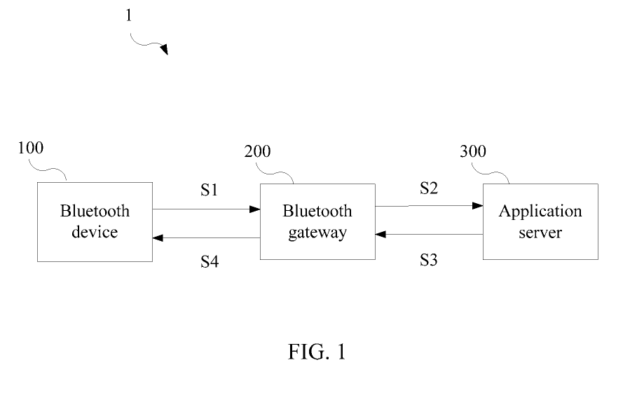

Please refer to FIG. 1. FIG. 1 shows a functional block diagram of the embodiment of the Bluetooth data access system 1 of the present invention. The Bluetooth data access system 1 comprises a Bluetooth device 100, a Bluetooth gateway 200, and an application server 300. The Bluetooth device 100 is for sending a broadcast message S1. The Bluetooth gateway 200 scans the Bluetooth wireless communication channel to receive the broadcast message S1 sent by the Bluetooth device 100. Then the Bluetooth gateway 200 sends a gateway message S2 containing the broadcast message S1. The application server 300 is connected to the Bluetooth gateway 200 to receive the gateway message S2, and the application server 300 generates and sends an application message S3 according to the gateway message S2. Wherein, the Bluetooth gateway 200 receives the application message S3, generates a control message S4 according to the application message S3, and then sends the control message S4 to the Bluetooth device 100 to access or operate the Bluetooth device 100.

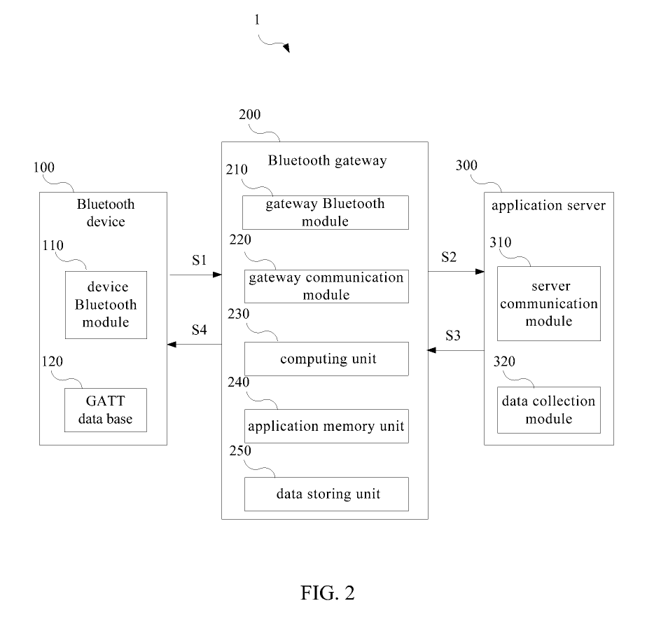

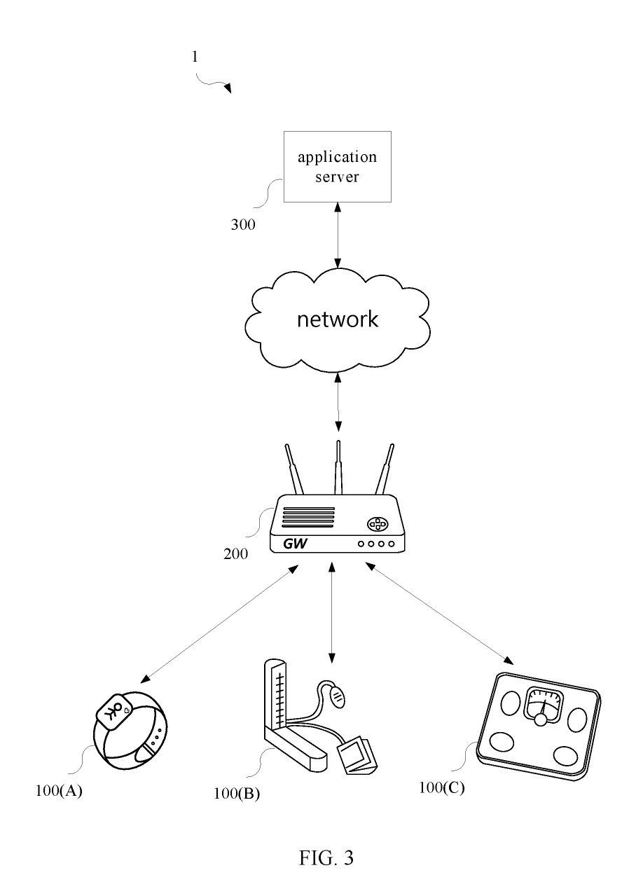

Please refer to FIG. 2 and FIG. 3. FIG. 2 shows another functional block diagram of the embodiment of the Bluetooth data access system 1 of the present invention. FIG. 3 shows a schematic diagram of the embodiment of the Bluetooth data access system 1 of the present invention. In an embodiment, the Bluetooth device 100 comprises a device Bluetooth module 110; the Bluetooth gateway 200 comprises a gateway Bluetooth module 210. In the embodiment, the Bluetooth device 100 may be a sensing instrument with Bluetooth communication. The Bluetooth device 100 regularly sends the broadcast message S1 via the device Bluetooth module 110. Wherein, the broadcast message may comprise a device identified code, a universally unique identifier, a combination code of the device identified code and the universally unique identifier, device model, device name, device serial number, or any code could be used to identify the device model. The Bluetooth gateway 200 searches the surrounding broadcast message S1. After searching out the broadcast message S1, the gateway Bluetooth module 210 is used to receive the relevant data. In another embodiment, the Bluetooth device 100 regularly sends the broadcast message S1 via the device Bluetooth module 110, and the broadcast message S1 contains a device identified code. When the Bluetooth gateway 200 searches out the broadcast message S1, the Bluetooth gateway 200 establishes a connection to the Bluetooth device 100 via the gateway Bluetooth module 210. After that, the Bluetooth device 100 transmits the other relative information to the Bluetooth gateway 200.

Please refer to FIG. 2 and FIG. 3 again. In an embodiment, the Bluetooth gateway 200 comprises a gateway communication module 220; the application server 300 comprises a server communication module 310. When the Bluetooth gateway 200 receives the broadcast message S1, the Bluetooth gateway 200 communicates with the server communication module 310 of the application server 300 via the gateway communication module 220, and sends the gateway message S2 to the application server 300. Wherein, the gateway message S2 comprises the broadcast message S1 and a gateway identified code of the Bluetooth gateway 200. The gateway identified code is a unique identified code of the Bluetooth gateway. The connection way between the Bluetooth gateway 200 and the application server 300 may be the wired connection or the wireless connection through the intranet or the internet.

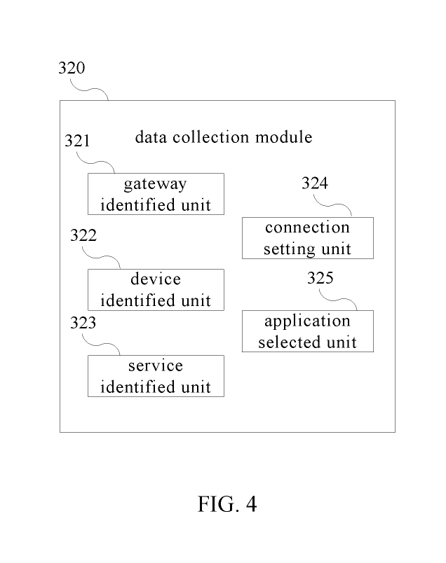

Please refer to FIG. 2 and FIG. 4. FIG. 4 shows a functional block diagram of the 320 of the embodiment of the Bluetooth data access system 1 of the present invention. In an embodiment, the application server 300 further comprises a data collection module 320. The data collection module 320 comprises a gateway identified unit 321, a device identified unit 322, a service identified unit 323, a connection setting unit 324, and an application selected unit 325. When the application server 300 receives the gateway message S2, the application server 300 selects an application able to communicate with the Bluetooth device 100 to send back to the Bluetooth gateway 200. The user may access the application server 300, and register the relative information of the Bluetooth device 100 and the Bluetooth gateway 200 in the data collection module 320. Otherwise, the relative information may be registered by the trader before selling the Bluetooth device 100. A plurality of gateway identified codes and the information of the Bluetooth device 100 corresponding to each gateway identified code are pre-stored in the gateway identified unit 321. The device identified unit 322 pre-stores a plurality of device identified codes. The service identified unit 323 pre-stores a plurality of universally unique identifiers. The connection setting unit 324 is used to provide a processing way and a processing parameter. The processing way and processing parameter process the wireless signal between the Bluetooth gateway 200 and the Bluetooth device 100. The application selected unit 325 pre-stores a plurality of applications able to process data exchange procedure with the difference Bluetooth devices 100.

First, the gateway identified unit 321 is used to identify the gateway identified code of the gateway message S2 by the data collection module 320. The Bluetooth device 100 corresponding to the Bluetooth gateway 200 is screened out after identifying the source of the Bluetooth gateway 200. Moreover, the device identified code of the gateway message S2 is used to identify the name, the serial number, or other information of the Bluetooth device 100 by the device identified unit 322. Then the service identified unit 323 utilizes the universally unique identifier of the gateway message S2 to identify the service contents requested by the Bluetooth device 100. After that, the connection setting unit 324 and the application selected unit 325 select and provide the corresponding application and setup a parameter to the application server 300 according to the identification result. Then the application server 300 sends the application message S3 containing application and the setup parameter via the server communication module 310.

Please refer to FIG. 2 again. In an embodiment, the Bluetooth gateway 200 further comprises a computing unit 230 and an application memory unit 240. When the Bluetooth gateway 200 receives the application message S3 feedbacked by the application server 300, the application and the setup parameter in the application message S3 are translated through the computing unit 230. The translation content contains but not limited to machine language, state describe language, or scripting language. Moreover, the Bluetooth gateway 200 transmits the control message S4 to the Bluetooth device 100 via the gateway Bluetooth module 210 to access or operate the Bluetooth device 100. The application memory unit 240 is used for storing the relative content of the application message S3. Therefore, when the user uses the same function, the Bluetooth gateway 200 could accomplish the operation without connecting to the application server 300.

Please refer to FIG. 2 again. In an embodiment, the Bluetooth gateway 200 further comprises a data storing unit 250, and the Bluetooth device 100 further comprises a GATT (Generic Attribute) data base 120. The Bluetooth gateway 200 utilizes the control message S4 to progress the operation function defined by the Bluetooth SIG to the GATT data base 120 of the Bluetooth device 100. Wherein, the GATT data base 120 comprises a plurality of services; each service is corresponding to a universally unique identifier, and each service further comprises a plurality of characteristics. The Bluetooth gateway 200 exchanges the service message content by revising or accessing the characteristic of the GATT data base 120. In an embodiment, the Bluetooth gateway 200 commands the Bluetooth device 100 by the control message S4 to transmit the service message content to the Bluetooth gateway 200. The service message content relative data will be temporarily stored in the data storing unit 250 of the Bluetooth gateway 200. The user could directly read the service message content through an electric device connected to the Bluetooth gateway 200, or the Bluetooth gateway 200 is used to directly read the service message content, or the Bluetooth gateway 200 uploads the service message content to the application server 300 to store and analyze, or the service message content is temporarily stored in the data storing unit 250 when the Bluetooth gateway 200 and the application server 300 are disconnected and is uploaded to the application server 300 to store and analyze when the connection is recovery.

In practice, the Bluetooth device 100 is a carbon dioxide detector, and the carbon dioxide concentration is detected every five seconds. The carbon dioxide detector sends the broadcast message S1, wherein the broadcast message S1 comprises the universally unique identifier for reading the carbon dioxide concentration and the device identified code of the carbon dioxide detector. After the Bluetooth gateway 200 receives the broadcast message S1, the broadcast message S1 and the gateway identified code of the Bluetooth gateway 200 are packaged to the gateway message S2 to be sent to the application server 300. The application server 300 utilizes the data collection module 320 to select the application may read the carbon dioxide concentration, and sets the detecting interval time of the detector through the connection setting unit 324, then sends the application message S3 to the Bluetooth gateway 200. After the Bluetooth gateway 200 receives the application message S3, the computing unit 230 is used to translate the application message S3 and generate the control message S4. Then the Bluetooth gateway 200 accesses the GATT data base 120 of the Bluetooth device 100 through the control message S4 to read the service message content of the carbon dioxide concentration detected by the carbon dioxide detector, which is the carbon dioxide concentration data.

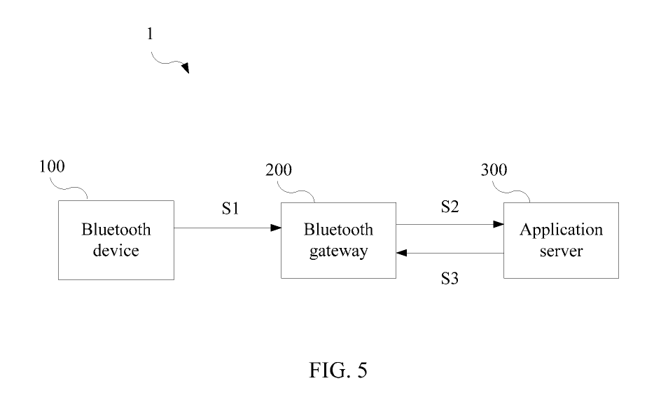

Please refer to FIG. 5. FIG. 5 shows another functional block diagram of the data collection module of the embodiment of the Bluetooth data access system 1 of the present invention. In another embodiment, the Bluetooth data access system 1 of the present invention comprises a Bluetooth device 100, a Bluetooth gateway 200, and an application server 300. The Bluetooth device 100 is for sending a broadcast message S1. The broadcast message S1 comprises a universally unique identifier, a service information, and a device identified code of the Bluetooth device 100, wherein the service information is the specific data form of the service, the specific data form can be information with or without encryption. The Bluetooth gateway 200 scans the Bluetooth wireless communication channel to receive the broadcast message S1 sent by the Bluetooth device 100. Then the Bluetooth gateway 200 sends a gateway message S2 according to the broadcast message S1. Wherein, the gateway message S2 comprises the device identified code of the Bluetooth device 100 and a gateway identified code of the Bluetooth gateway 200. The application server 300 is connected to the Bluetooth gateway 200 for receiving the gateway message S2. According to the gateway message S2, the application server 300 selects the application able to analyze the service content of the Bluetooth device 100, and then sends the application message S3 containing the application to the Bluetooth gateway 200. Wherein, after the Bluetooth gateway 200 receives the application message S3, the application of the application message S3 is used to translate the service information to obtain a service message content. In practice, the Bluetooth gateway 200 may send the obtained service message content to the application server 300 to store or analyze the data.

In practice, the Bluetooth device 100 may be a smart bracelet and monitors the heartbeat value of the user. The smart bracelet sends the broadcast message S1, wherein the broadcast message S1 comprises the heartbeat value with encryption and the device identified code of the smart bracelet. When the Bluetooth gateway 200 receives the broadcast message S1, the device identified code of the smart bracelet and the gateway identified code of the Bluetooth gateway 200 is packaged to the gateway message S2 to be sent to the application server 300. The application server 300 selects the application able to analyze the message with encryption, and then sends the application message S3 containing the application to the Bluetooth gateway 200. After the Bluetooth gateway 200 receives the application message S3, the application of the application message S3 is used to translate the heartbeat value with encryption to obtain the heartbeat value of the user.

In practice, the Bluetooth device 100 may be a Bluetooth blood pressure monitor for taking the blood pressure of the user. The Bluetooth device 100 (blood pressure monitor) provides a blood pressure measurement service (org.bluetooth.service.blood_pressure) defined by the Bluetooth Special Interest Group (SIG). The service provides a number of service characteristics, comprising the measurement result characteristic (org.bluetooth.characteristic.blood_pressure measurement), the measurement process characteristic (org.bluetooth.characteristic.intermediate_cuff_pressure), and the monitor feature support characteristic (org.bluetooth.characteristic.blood_pressure_feature). The Bluetooth blood pressure monitor sends the broadcast message S1 after measurement, wherein the broadcast message S1 comprises the GAP code (Generic Access Profile) defined by the Bluetooth Special Interest Group, and the GAP code is the blood pressure service code ┌0x1810┘ defined by the Bluetooth Special Interest Group and the device identified code of the Bluetooth blood pressure monitor. When the Bluetooth gateway 200 receives the broadcast message S1, the broadcast message S1 and the gateway identified code of the Bluetooth gateway 200 are packaged to the gateway message S2 to be sent to the application server 300. The application server 300 selects the application able to analyze blood pressure measurement service defined by the Bluetooth Special Interest Group, and then sends the application message S3 containing the application to the Bluetooth gateway 200. After the Bluetooth gateway 200 receives the application message S3, the application of the application message S3 is used to obtain a connection parameter, the control message S4, and the operational logic of application message S3 translation to access the blood pressure monitor. Through the connection parameter, the Bluetooth gateway 200 and the Bluetooth blood pressure monitor establish a Bluetooth connection, and the control message S4 is used to access or operate the blood pressure monitor. Wherein, the control message S4 is an operation instruction assembled based on Generic Attributes (GATT) of Attribute Protocol (ATT). The operation instruction assemble comprises “characteristic value reads the monitor feature support characteristic”, “characteristic value write to characteristic descriptors of the measurement process characteristic”, and “characteristic value write to characteristic descriptors of the measurement result characteristic”. Through the operation of instruction assembled, the blood pressure monitor provides the data of measurement process characteristic through the feature of characteristic value notification while measuring the blood pressure, and then provides the data of the measurement result characteristic when the measurement is done. The Bluetooth gateway 200 may analyze the data of measurement process characteristic and the data of the measurement result characteristic through the translation logic provided by the application message S3. Therefore, the blood pressure data and the result of the user are obtained. In this embodiment, the translation logic of the application message S3 comprises the measurement characteristic format defined by the Bluetooth SIG. The characteristic format provides one or more data measurement properties including the data unit, the data format, the validity of measurement, and other relevant information.

In practice, the Bluetooth device 100 may be a Bluetooth blood oximeter for taking the blood oxygen saturation of the user. The Bluetooth device 100 (blood oximeter) provides a blood oxygen measurement service (org.bluetooth.service.pulse_oximeter) defined by the Bluetooth Special Interest Group. The service provides a number of service characteristics, comprising the blood oxygen sampling measurement characteristic (org.bluetooth.characteristic.plx_spot_check_measurement), the blood oxygen continuous measurement characteristic (org.bluetooth.characteristic.plx_continuous_measurement), and the measurement record access control characteristic (org.bluetooth.characteristic.record_access_control_point). The Bluetooth blood oximeter sends the broadcast message S1 while turning on, wherein the broadcast message S1 comprises the GAP code defined by the Bluetooth Special Interest Group, and the GAP code is the blood oxygen measurement service code ┌0x1822┘ defined by the Bluetooth Special Interest Group and the device identified code of the Bluetooth blood oximeter. When the Bluetooth gateway 200 receives the broadcast message S1, the broadcast message S1 and the gateway identified code of the Bluetooth gateway 200 are packaged to the gateway message S2 to be sent to the application server 300. The application server 300 selects the application able to analyze blood oxygen measurement service defined by the Bluetooth Special Interest Group, and then sends the application message S3 containing the application to the Bluetooth gateway 200. After the Bluetooth gateway 200 receives the application message S3, the application of the application message S3 is used to obtain a connection parameter, the control message S4, and the operational logic of application message S3 translation to access the oximeter. Through the connection parameter, the Bluetooth gateway 200 and the Bluetooth blood oximeter establish a Bluetooth connection, and the control message S4 is used to access or operate the blood oximeter. Wherein, the control message S4 is an operation instruction assembled based on Generic Attributes of Attribute Protocol. The operation instruction assemble comprises “characteristic value read the measurement record access control characteristic”, and “characteristic value write to characteristic descriptors of the blood oxygen continuous measurement characteristic”. After the Bluetooth connection is established between the Bluetooth gateway 200 and the oximeter, through the operation of instruction assemble, the Bluetooth gateway 200 obtains the data of measurement process recorded by the oximeter through the feature of reading the measurement record access control characteristic. Then the Bluetooth gateway 200 receives the data of the measurement through the feature of blood oxygen continuous measurement characteristic. The Bluetooth gateway 200 may analyze the data of measurement record access control characteristic and the data of blood oxygen continuous measurement characteristic through the translation logic provided by the application message S3. Therefore, the previous and current continuous blood oxygen data are obtained. In this embodiment, the translation logic of the application message S3 comprises the blood oxygen continuous measurement characteristic format defined by the Bluetooth SIG. The characteristic format provides one or more data measurement properties including the data unit, the data format, the validity of measurement, and other relevant information.

In practice, the Bluetooth device 100 may be a Bluetooth wearable falling detector for detecting the falling of the user and sending a warning signal. The Bluetooth device 100 (wearable falling detector) provides a customized falling detecting service defined by the detector manufacturer. The customized falling detecting service provides one or more service characteristics comprising the falling detecting characteristic and the movement after falling characteristic. While detecting the falling happen, the wearable falling detector sends the broadcast message S1, wherein the broadcast message S1 comprises the GAP code defined by the Bluetooth Special Interest Group, the GAP code is the customized falling detecting service code defined by the Manufacturer Specific Data provided by the Bluetooth Special Interest Group and the device identified code of the Bluetooth wearable falling detector. When the Bluetooth gateway 200 receives the broadcast message S1, the broadcast message S1 and the gateway identified code of the Bluetooth gateway 200 are packaged to the gateway message S2 to be sent to the application server 300. The application server 300 selects the application able to analyze falling detecting service defined by the detector manufacturer, and then sends the application message S3 containing the application to the Bluetooth gateway 200. After the Bluetooth gateway 200 receives the application message S3, the application of the application message S3 is used to obtain a connection parameter, the control message S4, and the operational logic of application message S3 translation to access the wearable falling detector. Through the connection parameter, the Bluetooth gateway 200 and the Bluetooth wearable falling detector establish a Bluetooth connection, and the control message S4 is used to access or operate the blood wearable falling detector. Wherein, the control message S4 is an operation instruction assembled based on Generic Attributes of Attribute Protocol. The operation instruction assemble comprises “characteristic value read the falling detecting characteristic”, and “characteristic value write to characteristic descriptors of the movement after falling characteristic”. After the Bluetooth connection is established between the Bluetooth gateway 200 and the wearable falling detector, through the operation of instruction assemble, the Bluetooth gateway 200 obtains the data of falling by the wearable falling detector to determine the severity through the feature of reading the falling detecting characteristic, and continuously receives the movement of the user after falling through the movement after falling characteristic. The Bluetooth gateway 200 analyzes the falling detecting characteristic data to determine the severity by the translation logic provided by the application message S3, and analyzes the movement after falling characteristic data to determine whether the user's body lost the ability to move due to fall, and further reports to the application server 300.

Please refer to FIG. 3 again. In practice, the Bluetooth device 100 is not limit to the above mentioned application. The Bluetooth device 100 can be any kinds of the devices equipped with Bluetooth connectivity, such as the smart bracelet 100(A), the Bluetooth blood pressure monitor 100(B), the Bluetooth weight scale 100(C), Bluetooth thermometers, Bluetooth heart rate meters, Bluetooth oximeter, Bluetooth wearable falling detectors, Bluetooth electrocardiogram detectors, Bluetooth breath detectors, Bluetooth hygrometers, Bluetooth soil hygrometers, Bluetooth pH meters, and the sensors measuring environments, humans or animals. Otherwise, the Bluetooth device 100 can be a controller with Bluetooth connectivity, such as Bluetooth switches, Bluetooth relays, Bluetooth motor controllers, Bluetooth variable resistors, Bluetooth voltage output controls, Bluetooth current output controls or a Bluetooth controller with an industrial communication protocol. Wherein, the industrial communication protocol can be Modbus, RS-232, RS-485, Modbus TCP, Profinet, EtherCAT and other commonly used industrial communication protocols. The mentioned Bluetooth device 100 sends the broadcast message S1 via the device Bluetooth module 110. The Bluetooth gateway 200 sends the gateway message S2 containing the broadcast message S1 after receiving the broadcast message S1. The application server 300 is connected to the Bluetooth gateway 200 to receive the gateway message S2, and then the application server 300 generates and sends the application message S3 according to the gateway message S2. Wherein, the Bluetooth gateway 200 receives the application message S3, then generates and sends the control message S4 according to the application message S3 to access or operate the Bluetooth device 100.

The Bluetooth in the mentioned embodiment may be any versions of the Bluetooth communication protocol defined by the Bluetooth Special Interest Group, such as the Bluetooth 2.0 protocol series, the Bluetooth 3.0 protocol series, the Bluetooth 4.0 protocol series or the Bluetooth 5.0 protocol series Bluetooth devices.

The wired connection in the mentioned embodiment is through a wired network. The wired network may be Ethernet, FTTx, Power line communications, and networks able to deliver the network packet.

The wireless connection in the mentioned embodiment is through a wireless network. The wireless network may be wireless LAN or mobile communications network.

The wireless LAN in the mentioned embodiment may be any versions of the 802.11 protocol defined by Wi-Fi or IEEE, such as 802.11, IEEE 802.11a, 802.11b, 802.11g, 802.11h, 802.11n, 802.11p, 802.11ac, 802.11ah, 802.11aq, 802.11ax and so on.

The mobile communications network in the mentioned embodiment may be LoRa, Sigfox or the network agreement of Release 4, Release 5, Release 6, Release 7, Release 8, Release 9, Release 10, Release 11, Release 12, Release 13, or Release 14 released by 3GPP, or other mobile communications network agreement approved by ITU.

Compared with the prior art, the Bluetooth data access system of the present invention provides the corresponding application to the Bluetooth gateway according to different Bluetooth devices from the application server, so that the Bluetooth gateway can dynamically access or operate various Bluetooth devices without the inherent application, unlike the normal Bluetooth gateway requires an inherent application for various Bluetooth devices to access or operate the Bluetooth devices. Therefore, compared with the normal Bluetooth gateway, the Bluetooth gateway of the present invention can save the storage capacity for various applications. Moreover, the user could operate the different Bluetooth devices conveniently without installing on user's own.

The mobile communications network in the mentioned embodiment may be LoRa, Sigfox, or the protocol network of Release 4, Release 5, Release 6, Release 7, Release 8, Release 9, Release 10, Release 11, Release 12, Release 13, and Release 14 released by the 3GPP association, or other communications protocol network approved by the ITU (International Telecommunication Union).

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A Bluetooth data access system, comprising:
a Bluetooth device, for sending a broadcast message;
a Bluetooth gateway, coupled to the Bluetooth device to receive the broadcast message, wherein the Bluetooth gateway is configured for sending a gateway message containing the broadcast message; and
an application server, connected to the Bluetooth gateway to receive the gateway message, wherein the application server generates and sends an application message according to the gateway message;
wherein, the Bluetooth gateway receives the application message, generates a control message and then sends the control message to access or operate the Bluetooth device.

2. The Bluetooth data access system of claim 1, wherein the broadcast message comprises a device identified code, a universally unique identifier, or a combination thereof; the device identified code is a unique identified code of the Bluetooth device, and the universally unique identifier is an identified code of service contents for the Bluetooth device.

3. The Bluetooth data access system of claim 1, wherein the gateway message contains the broadcast message and a gateway identified code, and the gateway identified code is a unique identified code of the Bluetooth gateway.

4. The Bluetooth data access system of claim 1, wherein the application server comprises a data collection module; the data collection module prestores an application able to access or operate the Bluetooth device, and the application server selects the application and generates the application message containing the application according to the gateway message.

5. The Bluetooth data access system of claim 4, wherein the data collection module further comprises a device identified code of the Bluetooth device, a universally unique identifier of the Bluetooth device, and a gateway identified code of the Bluetooth gateway; the device identified code is a unique identified code of the Bluetooth device, the universally unique identifier is an identified code of service contents for the Bluetooth device, and the gateway identified code is a unique identified code of the Bluetooth gateway.

6. The Bluetooth data access system of claim 1, wherein the Bluetooth gateway comprises a computing unit; after the Bluetooth gateway receives the application message, the computing unit is configured to translate the application message to the control message.

7. The Bluetooth data access system of claim 6, wherein the Bluetooth gateway further comprises an application memory unit for storing the application message provided by the application server, and when the Bluetooth gateway is disconnected from the application server, the computing unit is able to access the application message stored in application memory unit and translates the application message to the control message.

8. The Bluetooth data access system of claim 1, wherein the Bluetooth gateway accesses or operates the Bluetooth device to obtain a service message content, and the Bluetooth gateway sends the service message content to the application server.

9. The Bluetooth data access system of claim 1, wherein the Bluetooth gateway comprises a data storing unit for storing a service message content obtained by the Bluetooth gateway accessing or operating the Bluetooth device.

10. The Bluetooth data access system of claim 9, wherein the data storing unit stores the service message content when the Bluetooth gateway is disconnected from the application server, and the service message content is sent to the application server when the Bluetooth gateway and the application server connection is recovered.

11. The Bluetooth data access system of claim 1, wherein the Bluetooth gateway further comprises an application memory unit for storing the application message provided by the application server.

12. A Bluetooth data access system, comprising:
a Bluetooth device, for sending a broadcast message, and the broadcast message containing a service information;
a Bluetooth gateway, coupled to the Bluetooth device to receive the broadcast message, wherein the Bluetooth gateway is configured for sending a gateway message according to the broadcast message; and
an application server, connected to the Bluetooth gateway to receive the gateway message, wherein the application server generates and sends an application message;
wherein, the Bluetooth gateway receives the application message, and the application message is for translating the service information to generate a service message content.

13. The Bluetooth data access system of claim 12, wherein the broadcast message comprises a device identified code, a universally unique identifier, or a combination thereof; the device identified code is a unique identified code of the Bluetooth device, and the universally unique identifier is an identified code of service contents for the Bluetooth device.

14. The Bluetooth data access system of claim 12, wherein the gateway message contains the broadcast message and a gateway identified code, and the gateway identified code is a unique identified code of the Bluetooth gateway.

15. The Bluetooth data access system of claim 12, wherein the application server comprises a data collection module, the data collection module prestores an application able to translate the service information, and the application server selects the application and generates the application message containing the application according to the gateway message.

16. The Bluetooth data access system of claim 15, wherein the data collection module further comprises a device identified code of the Bluetooth device, a universally unique identifier of the Bluetooth device, and a gateway identified code of the Bluetooth gateway; the device identified code is a unique identified code of the Bluetooth device, the universally unique identifier is an identified code of service contents for the Bluetooth device, and the gateway identified code is a unique identified code of the Bluetooth gateway.

17. The Bluetooth data access system of claim 15, wherein the Bluetooth gateway comprises a computing unit; the computing unit translates the service information to obtain the service message content by the application of the application message, and the Bluetooth gateway sends the service message content to the application server.

18. The Bluetooth data access system of claim 17, wherein the Bluetooth gateway further comprises an application memory unit for storing the application message provided by the application server; when the Bluetooth gateway is disconnected from the application server, the computing unit is able to access the application message stored in application memory unit and translates the service information by the application of the application message.

19. The Bluetooth data access system of claim 12, wherein the Bluetooth gateway comprises a data storing unit for storing the service message content.

20. The Bluetooth data access system of claim 19, wherein the data storing unit stores the service message content when the Bluetooth gateway is disconnected from the application server, and the service message content is sent to the application server when the Bluetooth gateway and the application server connection is recovered.

21. The Bluetooth data access system of claim 12, wherein the Bluetooth gateway further comprises an application memory unit for storing the application message provided by the application server.
